(19) United States
(12) Patent Application Publication
(10) Pub. No.: US 2010/0122265 A1
(43) Pub. Date: May 13, 2010

(54) CROSS - APPLICATION TAG REUSE

(75) Inventors: Kristina Beckley, Carlisle, MA (US); Yao Pang Alexis Song, Cary, NC (US); Smriti Talwar, Clonsilla (IE)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/266,583

(22) Filed: Nov. 7, 2008

(51) Int. Cl. G06F 9/54

(52) U.S. Cl. 719/313

(57) ABSTRACT

A method of reusing tags includes retrieving a tag set from a first application of a computer system, the tag set including a plurality of descriptive tags, and transmitting the tag set to a target application, the target application employing the plurality of descriptive tags to enforce a standard tagging format in new tags created within the target application.

### BACKGROUND

This invention generally relates to tag sets. More particularly, this invention relates to a system and method of reusing established tag sets across multiple applications.

A tagging system allows users to attach tag information to objects or information of a computer system. Thereafter, other users may access the tag information, or tags, to locate items of interest. A unique feature of tags is that tags are user-defined in contrast to being preset by an application or system. This feature allows a user to attach tags with meaning for the user, which may later be used to organize information. However, it may become cumbersome for a user to continually create new tags across several applications in a computer system. Furthermore, as tags are created by a plurality of users, it may be difficult to maintain or enforce a standard format of tags system-wide. Therefore, example embodiments of the present invention provide features which may reduce these issues.

### SUMMARY

According to an example embodiment, a method of reusing tags includes retrieving a tag set from a first application of a computer system, the tag set including a plurality of descriptive tags, and transmitting the tag set to a target application, the target application employing the plurality of descriptive tags to enforce a standard tagging format in new tags created within the target application.

Additional features and advantages are realized through the techniques of the exemplary embodiments described herein. Other embodiments and aspects of the invention are described in detail herein and are considered a part of the claimed invention. For a better understanding of the invention with advantages and features, refer to the detailed description and to the drawings.

### BRIEF DESCRIPTION OF SEVERAL VIEWS OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates the reuse of tags between applications, according to an example embodiment;

FIG. 2 illustrates the shared use of a portable tag set, according to an example embodiment;

FIG. 3 illustrates a flow chart of a method of reusing tags, according to an example embodiment; and

FIG. 4 illustrates a computer apparatus, according to an example embodiment.

The detailed description explains an exemplary embodiment, together with advantages and features, by way of example with reference to the drawings.

### DETAILED DESCRIPTION

According to an exemplary embodiment, a system and methodology are provided which significantly decrease the complexity of creating new and/or similar and/or similarly formatted tags across multiple applications of a computer system. This decrease in complexity effectively results in better data organization, easier searching of information, and system-wide standardization of tag use.

A tag-based system may provide suggested tags as a user begins to type or create a new tag. These suggestions often provide information about the frequency of use of a particular tag and other information such as similar tags employed by this user and various other groups of users. The effect of this feature is to normalize the set of tags such that users who may begin with a particular format of tags may gradually become accustomed to a standardized outline for tag creation. The system may further include information concerning other users' tag use. The system's ability to drive consistency is dependent upon a good tag base or set being employed by the system.

Over time, an organization or individual may develop a set of commonly used tags (e.g., a tag base) which represent desired tag names as well as the influence of site/application driven suggestions based on previously created tags. Furthermore, a company or other entity may desire a particular format of tags, for example, standard terminology or other similar features within tags. It may be beneficial to extend, share, or export the tag base to other applications to drive a system-wide form of tag consistency.

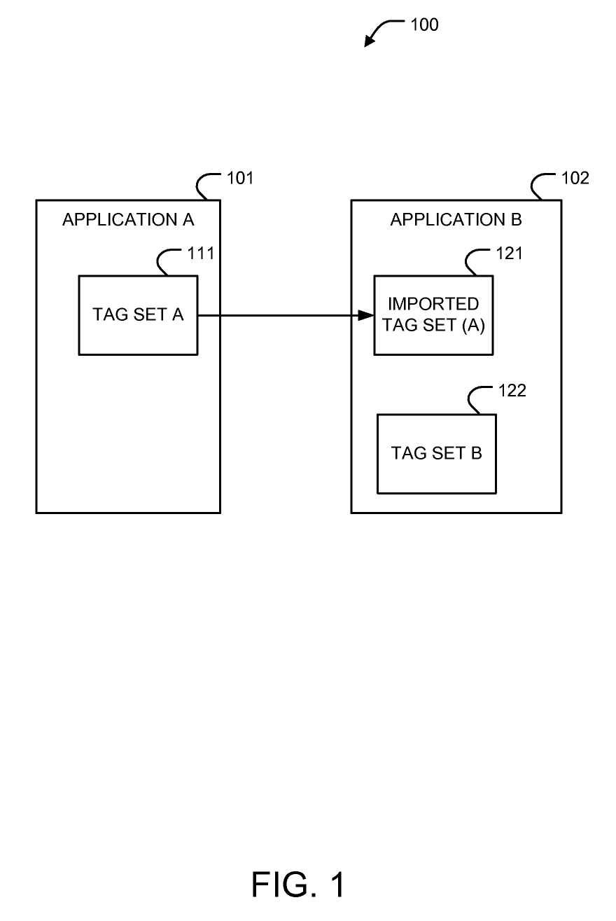

FIG. 1 illustrates the reuse of tags between applications, according to an example embodiment. According to the system 100, application A (101) and application B (102) both include respective tag sets (e.g., 111, 122). The tag set A 111 of application A 101 may be a tag set created by a particular user, or that of a group of users accessing system 100. The tag set A111 may also be a tag set created based on a standard terminology or other similar features for an organization or other entity. The tag set B 122 of application B 102 may be a tag set created by a particular user, or that of a group of users accessing the system 100. According to system 100, a tag set may be exported from one application and imported by another application. For example, tag set A 111 may be exported from application A 101. The exported tag set A may be imported by application B.

According to at least one example embodiment, a tag set in a standard format (exported from another application or otherwise created) may then be imported into a target application. The standard format may be a format of terminology or tag creation determined by an organization or other entity. For example, the standard format may be a format of tag creation made by a company desiring substantially similar tagging formats system-wide. Once imported, the tag set may be used to inform tagging suggestions for users creating their own tags in the target application. For an application not previously containing any tags, the imported set may serve as the base set. Once users start contributing their own tagging data (e.g., new tags and tag usage data etc.) to the system, these tags may form a tag superset or portable tag set for the system. If the target application already has tagging information, the combined sets may form a new tag superset to drive tag suggestions. Depending on user preference/application type, a user may be able to see information about tags suggested from a specific subset, and these subsets may include imported tag sets.

Furthermore, an organization may desire centrally managed tag sets to continually supply a merged (and possibly “adjusted”) tag set system-wide. These examples of portable tags and system-wide tags are described more fully below.

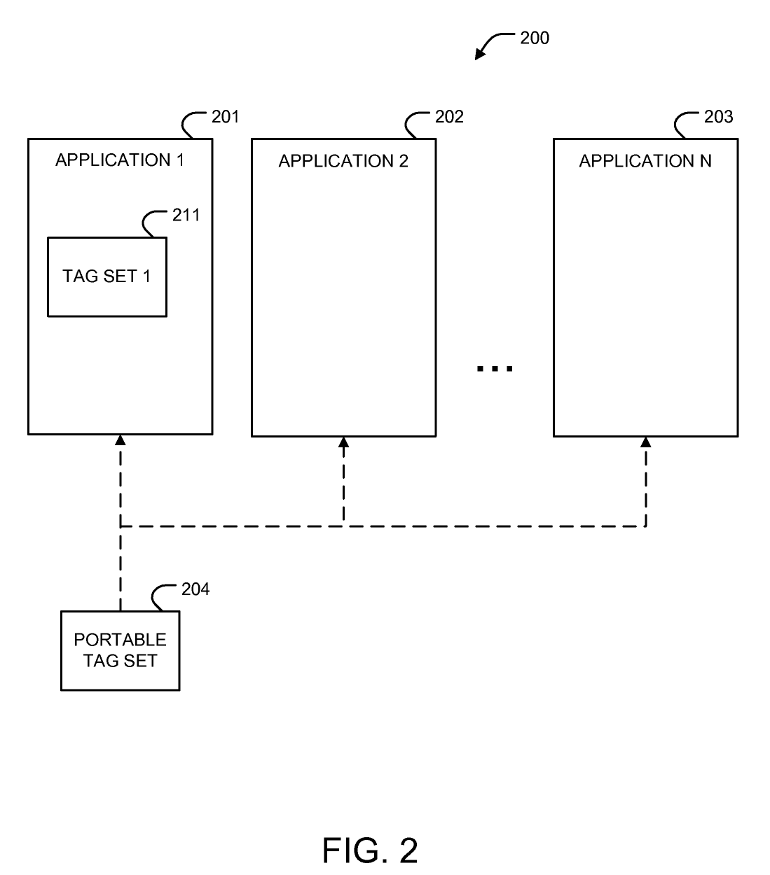

FIG. 2 illustrates the shared use of a portable tag set, according to an example embodiment. The system 200 may include a plurality of applications (201-203). Each application of the plurality of applications may include an application specific tag set (e.g., 211) or may simply use a shared or portable tag set (e.g., 204). The portable tag set may be a system managed tag set conforming to a standard format accessible to each application of the plurality of applications (201-203). The portable tag set may include a plurality of tags created by any number of users of the system 200. Furthermore, the plurality of tags may have been created on any of the plurality of applications (201-203). Alternatively, the portable tag set 204 may include tags created by a system administrator of system 200, may be provided by a content provider of standard tags, or any other suitable implementation. In this manner, an organization or system may employ standard or substantially similar tags.

For example, a user or organization may employ the portable tag set to import an established tag set (exported from another application or any other established tag set) into a new application. Once the imported set is in place, if a user adds a tag, the suggestions that appear for the new tag will be driven from the imported set of tags (or a combination of the imported tags and any existing tags). Thus an imported tag set may provide a starting point for all tagging in a new application and/or enhance tagging suggestions in an established application thereby establishing standard or substantially similar tagging system-wide. Furthermore, imported tag sets from existing applications when launching a new application may also increase the likelihood of consistent tagging across applications.

Using an imported tag set may be useful both when starting to use a new application and with an application that already has some user created tags. In an example of an application with existing tags, the imported portable tag set would be concatenated with the existing tag set. The resulting suggestions to the user would be based on a superset of tags comprising both the imported tag set and the current application tags with the option to include subset information to further assist the user in creating useful tags. Furthermore, other users attempting to access or locate information would find it much easier given the more consistent and substantially similar tagging system-wide.

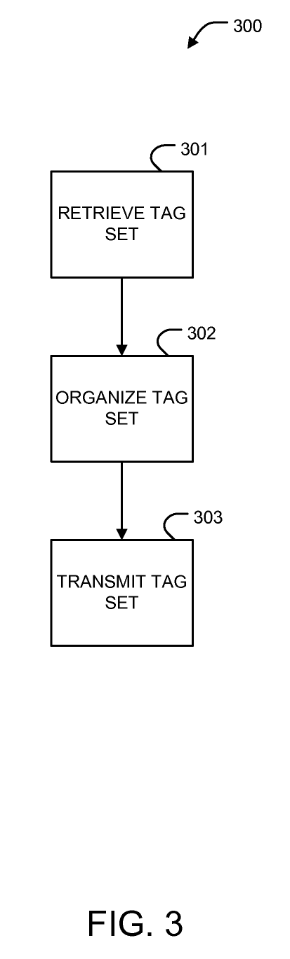

FIG. 3 illustrates a flow chart of a method of reusing tags, according to an example embodiment. The method 300 includes retrieving a tag set at block 301. The tag set may include a plurality of tags. Each tag of the plurality of tags may be user or administrator created. The tags may be of a standard format, of an application specific format, or each tag may be of a differing format. The tag set may be retrieved from an existing application or a system pool/portable tag set. The standard format maybe a format conforming to similar or substantially similar terminology and descriptors to enable more consistent tag creation and/or increased ascertainment of information by a plurality of users.

The method may further include organizing the retrieve tag set at block 302. For example, if the tag set includes tags of differing formats, the tags may be organized or standardized in a format accessible to applications or a group of applications of a computer system. Alternatively, the tag set may already be of a standard format or a usable format and thus this portion of the method 300 may be omitted entirely.

The method 300 further includes transmitting the retrieved tag set at block 303. The tag set may be transmitted to any application of a computer system, to an application creating a tag request, to a newly created or initialized application, or any suitable application. Furthermore, the tag set may be a portable tag set, and thus, may be transmitted to any application as a tag set update or as a centrally managed tag set.

For example, a research department within a pharmaceutical company may employ several applications (e.g., lab notebooks, reference data, papers, conference notes, etc) to create and store content related to research. If a new tag employing application is added, there is no need to “start from scratch” as one or more existing tag sets can be imported to ensure that tagging in this new application will encourage the use of tags that others will be able to effectively use to locate data. Merging tag sets may further aid the example research department in ensuring the tag suggestions offered across their tag employing applications are consistent.

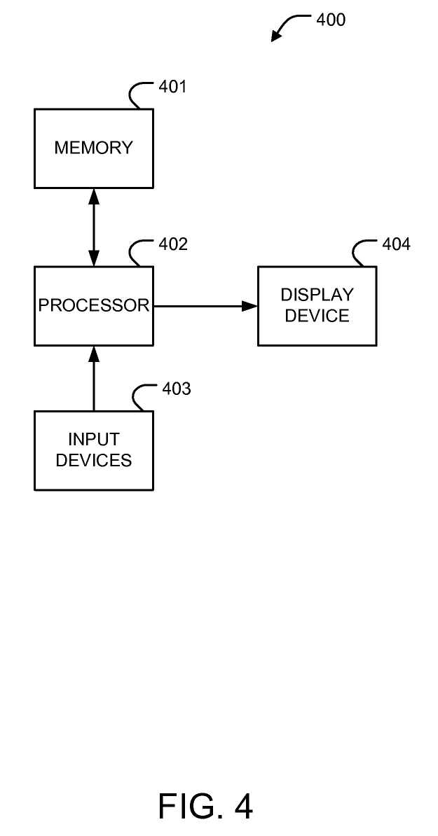

Furthermore, according to an exemplary embodiment, the methodologies described hereinbefore may be implemented by a computer system or apparatus. For example, FIG. 4 illustrates a computer apparatus, according to an exemplary embodiment. Therefore, portions or the entirety of the methodologies described herein may be executed as instructions in a processor 402 of the computer system 400. The computer system 400 includes memory 401 for storage of instructions and information, input device(s) 403 for computer communication, and display device 404. Thus, the present invention may be implemented, in software, for example, as any suitable computer program on a computer system somewhat similar to computer system 400. For example, a program in accordance with the present invention may be a computer program product causing a computer to execute the example methods described herein.

The computer program product may include a computer-readable medium having computer program logic or code portions embodied thereon for enabling a processor (e.g., 402) of a computer apparatus (e.g., 400) to perform one or more functions in accordance with one or more of the example methodologies described above. The computer program logic may thus cause the processor to perform one or more of the example methodologies, or one or more functions of a given methodology described herein.

The computer-readable storage medium may be a built-in medium installed inside a computer main body or removable medium arranged so that it can be separated from the computer main body. Examples of the built-in medium include, but are not limited to, rewriteable non-volatile memories, such as RAMs, ROMs, flash memories, and hard disks. Examples of a removable medium may include, but are not limited to, optical storage media such as CD-ROMs and DVDs; magneto-optical storage media such as MOs; magnetism storage media such as floppy disks (trademark), cassette tapes, and removable hard disks; media with a built-in rewriteable non-volatile memory such as memory cards; and media with a built-in ROM, such as ROM cassettes.

Further, such programs, when recorded on computer-readable storage media, may be readily stored and distributed. The storage medium, as it is read by a computer, may enable the method(s) disclosed herein, in accordance with an exemplary embodiment of the present invention.

With an exemplary embodiment of the present invention having thus been described, it will be obvious that the same may be varied in many ways. The description of the invention hereinbefore uses this example, including the best mode, to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Such variations are not to be regarded as a departure from the spirit and scope of the present invention, and all such modifications are intended to be included within the scope of the present invention as stated in the following claims.

What is claimed is:

1. A method of reusing tags comprising:
retrieving a tag set from a first application of a computer system, the tag set including a plurality of descriptive tags; and
transmitting the tag set to a target application, the target application employing the plurality of descriptive tags to enforce a standard tagging format in new tags created within the target application.

2. The method of claim 1, further comprising organizing the plurality of descriptive tags based on the standard tagging format.

3. The method of claim 1, wherein the tag set is maintained by an organization administering the first application and the target application.

4 The method of claim 1, wherein the tag set is a portable tag employed by a plurality of applications.

5. The method of claim 4, wherein the portable tag set is maintained by an organization, and the portable tag set is configured to organize information and/or computer files of a computer system through descriptive terms substantially similar to terms employed by the entire computer system.

6. The method of claim 5, wherein the computer system includes a plurality of computer apparatuses, and each computer apparatus of the plurality of computer apparatuses is configured to utilize the portable tag set.
